(19) United States
(12) Patent Application Publication
(10) Pub. No.: US 2026/0055485 A1
(43) Pub. Date: Feb. 26, 2026

(54) TARGETED EXTRACTION OF RARE EARTH ELEMENTS, YTTRIUM AND RADIUM FROM MINERALOGICALLY CHARACTERIZED PHOSPHOGYPSUM

(71) Applicant: Florida State University Research Foundation, Inc., Tallahassee, FL (US)

(72) Inventors: Munir Humayun, Tallahassee, FL (US); Jane Alexandra Wadhams, Tallahassee, FL (US)

(21) Appl. No.: 19/308,938

(22) Filed: Aug. 25, 2025

Related U.S. Application Data
(60) Provisional application No. 63/686,276, filed on Aug. 23, 2024.

(51) Int. Cl. C22B 59/00; C22B 3/06; C22B 3/26; C22B 3/44

(52) U.S. Cl. CPC C22B 59/00; C22B 3/06; C22B 3/304; C22B 3/44

(57) ABSTRACT

Systems and methods are provided for separation/extraction of rare earth elements (REE), yttrium (Y), and/or radium (Ra) from phosphogypsum. Extraction of REE, Y, and/or Ra can be achieved by treating phosphogypsum with acidic aqueous media at ambient temperature in a reactor at low liquid:solid (L:S) ratios (e.g., L:S in a range of from 1:1 to 15:1), followed by ion exchange chromatography or solvent extraction of relevant anions and/or cations to ensure that the mineral hosts remain undersaturated while the gypsum remains saturated in the solvent. Grinding of the phosphogypsum (e.g., in a slurry mill) can be performed to ensure that minor mineral inclusions are fully accessed by the solvent.

### CROSS-REFERENCE TO RELATED APPLICATION

This application claims the benefit of U.S. Provisional Application Ser. No. 63/686,276, filed Aug. 23, 2024, the disclosure of which is hereby incorporated by reference in its entirety, including all figures, tables, and drawings.

### BACKGROUND

Demand for rare earth elements has been on the rise, driven by the transition to renewable energy technologies (e.g., electric motors, generators in wind turbines). The industrial extraction of phosphate for fertilizer from phosphate ores creates phosphogypsum waste, which includes most of the rare earth elements and yttrium (REY) contained in the original phosphate ore. There is currently no significant commercial rare earth element and/or yttrium extraction process from phosphogypsum, due at least in part to the cost of recovering diluted REY from large quantities of waste. Uranium present in the phosphate ore results in the transfer of its daughter, radium (Ra-226), to the phosphogypsum during processing, as a result of which phosphogypsum is prohibited for use in industrial applications, requiring costly stacking.

### BRIEF SUMMARY

Due to dilution by gypsum and sand, rare earth element (REE) and yttrium (Y) (collectively, REY) contents of phosphogypsum do not seem high enough to exploit (e.g., 0.02%-0.05%). No related art commercial process exists to extract REY from phosphogypsum, likely due to the cost of recovering diluted REY from large quantities of waste. Embodiments of the subject invention overcome these challenges by providing novel and advantageous systems and methods for separation/extraction of REE, Y, and/or radium (Ra) from phosphogypsum. Extraction of REE, Y, and/or Ra can be achieved by treating phosphogypsum with acidic aqueous media at ambient temperature in a reactor at low liquid:solid (L:S) ratios (e.g., L:S of no more than 15:1, such as in a range of from 1:1 to 15:1 or in a range of from 1:1 to 5:1), followed by ion exchange chromatography or solvent extraction of relevant anions or cations to ensure that the mineral hosts remain undersaturated while the gypsum remains saturated in the solvent. In order to achieve more efficient extraction, grinding of the phosphogypsum (e.g., in a slurry mill) can be performed to ensure that minor mineral inclusions are fully accessed by the solvent (see also FIG. 1). Systems and methods can be used to extracting valuable REE and Y (collectively, REY) from industrial waste, with the removal of Ra valorizing the residual gypsum for sale as a commercial product (e.g., in construction, agriculture, or other applicable fields).

In an embodiment, a method for extraction of REE, Y, and/or Ra from phosphogypsum can comprise: i) treating the phosphogypsum with an acidic aqueous medium in a reactor (e.g., an agitator tank) at an L:S ratio of no more than 15:1 (e.g., in a range of from 1:1 to 15:1, about 1:1 to about 15:1, 1:1 to 5:1, or about 1:1 to about 5:1) to give a first solution comprising dissolved gypsum (e.g., the first solution being saturated in gypsum) and to leave behind a gypsum residue (solid gypsum, with the majority of the gypsum being in the gypsum residue); and ii) performing a chemical extraction step on the first solution to remove at least one anion (e.g., fluorine (F)) and/or at least one cation (e.g., strontium (Sr) and/or barium (Ba)) and give a second solution (comprising dissolved gypsum) depleted in the at least one anion and/or the at least one cation (i.e., depleted compared to the first solution); iii) treating the gypsum residue with the second solution to extract more of the at least one anion and/or at least one cation from the gypsum residue; iv) performing a chemical extraction step (e.g., the same type of chemical extraction as performed in step ii)) on the second solution after step iii) to remove (at least some of) the at least one anion and/or the at least one cation, the second solution after this chemical extraction step (of step iv)) being undersaturated in the at least one anion and/or the at least one cation compared to the second solution before this chemical extraction step (of step iv)); v) repeating steps iii) and iv) a plurality of times (e.g., until dissolution of the at least one anion and/or the at least one cation is complete (or reaches a predetermined level)) to give a final gypsum residue and a third solution comprising REE, Y, and/or Ra; and vi) precipitating REE and/or Y from the third solution (i.e., at the conclusion of the process). The REE and/or Y can be precipitated using available methods, including as REY-carbonate, REY-oxalate, and/or REY-hydroxide. After step v) (i.e., repeating steps iii) and iv) a plurality of times), the final gypsum residue can contain at least a predetermined amount (e.g., at least 95% by weight) of the initial gypsum present in the phosphogypsum. Each chemical extraction step can comprise at least one of ion exchange chromatography and solvent extraction. Any or all of steps i), ii), iii), iv), and v) can be performed at ambient temperature. Step vi) can comprise first neutralizing the third solution. A concentration of Ra in the final residual gypsum (after step v)) can be at least 50% less (e.g., at least 75%, at least 90%, or at least 95% less) than that of the phosphogypsum. The final residual gypsum (after step v)) can have a radium activity of 10 picocuries per gram (pCi/g) or less (e.g., 5 pCi/g or less, or 1 pCi/g or less). The method can further comprise: either before step i) or concurrent with step i), grinding the phosphogypsum. The grinding of the phosphogypsum can be performed in a slurry mill before step i). The acidic aqueous medium can have a concentration of acid in a range of from 0.01 molar (M) to 2 M (e.g., from 0.01 M to 1 M). The acidic aqueous medium can comprise at least one mineral acid (e.g., nitric acid, hydrochloric acid, and/or sulfuric acid). Step ii) can comprise passing the first solution through: a fluoride-removal stage configured to remove fluorine from the first solution; and/or a strontium-removal stage configured to remove strontium from the first solution. Step ii) can further comprise, after passing the first solution through the fluoride-removal stage and/or the strontium-removal stage, recirculating the second solution back to the reactor. Step iv) can comprise passing the second solution through: a fluoride-removal stage configured to remove fluorine from the second solution; and/or a strontium-removal stage configured to remove strontium from the second solution. Step iv) can further comprise, after passing the second solution through the fluoride-removal stage and/or the strontium-removal stage, recirculating the second solution back to the reactor. Steps iii) and iv) can be repeated at least three times (e.g., at least ten times, at least 100 times, or more) before step vi) is performed. Step ii) can comprise using an extraction means (e.g., a vacuum filter and/or a centrifuge) to extract the first solution from the reactor. Step iv) can comprise using an extraction means (e.g., a vacuum filter and/or a centrifuge) to extract the second solution from the reactor. The fluoride-removal stage can comprise a fluoride-removal cartridge comprising alumina (Al₂O₃) and/or aluminum hydroxide (Al(OH)₃). The strontium-removal stage can comprise a strontium-specific resin column or solvent extraction (e.g., using a crown ether). A ratio of the mass of the REE obtained in step vi) to the mass of the REE present in the phosphogypsum can be at least 80% (e.g., at least 85%, at least 90%, or at least 95%). A ratio of the mass of the Y obtained in step vi) to the mass of the Y present in the phosphogypsum can be at least 80% (e.g., at least 85%, at least 90%, or at least 95%).

### BRIEF DESCRIPTION OF DRAWINGS

FIG. 1 shows a schematic of the possible structures within a phosphogypsum that host rare earth elements (REE) and yttrium (Y) (collectively, REY) and radium (Ra). The host of rare earth elements and yttrium is identified as the mineral chukhrovite [Ca_{4.5}(Al,Ln)₂(SO₄)F₁₃·12H₂O], where Ln is a lanthanide (REY), and the radium host is the mineral (Sr,Ba)SO₄. These minerals (labeled as “chukhrovite” or “mineral inclusion” in the figure) can occur in the spaces between gypsum crystals (labeled as “gypsum” in the figure) or as inclusions within the gypsum crystals. A goal of embodiments of the subject invention is to extract these minor minerals selectively without dissolving most of the gypsum.

FIG. 2 shows a schematic view of a system for separation/extraction of REE, Y, and Ra from phosphogypsum, according to an embodiment of the subject invention. The system in FIG. 2 employs ion exchange columns in a recirculating configuration for creating undersaturation of the solution in specific elements. Solid-liquid separation is depicted as a vacuum filter but could comprise any such device as affords effective separation (e.g., a centrifuge).

FIG. 3 shows a schematic view of a system for separation/extraction of REE, Y, and Ra from phosphogypsum, according to an embodiment of the subject invention. The system in FIG. 3 employs solvent extraction in place of ion exchange to lower the activity of strontium (Sr) in the solid.

FIGS. 4A-4D show laser ablation time-of-flight inductively coupled plasma mass spectrometry (ICP-MS) chemical images of a chukhrovite grain in phosphogypsum from Piney Point (Florida, United States), revealing that REE and Y (collectively, REY) are in the core of the grain. The chukhrovite can be Ca₃Al₃(SO₄)F₁₃·12H₂O; and the REY-substituted chukhrovite can be Ca₃(La, Y)Al₂(SO₄)F₁₃·12H₂O. Each image is of the same graine but for a different element; FIG. 4A is for aluminum; FIG. 4B is for calcium; FIG. 4C is for Y, and FIG. 4D is for lanthanum. The scale bar in each of FIGS. 4A-4D is 15 micrometers (μm).

### DETAILED DESCRIPTION

Embodiments of the subject invention provide novel and advantageous systems and methods for separation/extraction of rare earth elements (REE), yttrium (Y), and/or radium (Ra) from phosphogypsum. Extraction of REE, Y, and/or Ra can be achieved by treating phosphogypsum with acidic aqueous media at ambient temperature in a reactor at low liquid:solid (L:S) ratios (e.g., L:S of no more than 15:1, such as in a range of from 1:1 to 15:1), followed by ion exchange chromatography or solvent extraction of relevant anions or cations to ensure that the mineral hosts remain undersaturated while the gypsum remains saturated in the solvent. In order to achieve more efficient extraction, grinding of the phosphogypsum (e.g., in a slurry mill) can be performed to ensure that minor mineral inclusions are fully accessed by the solvent. Systems and methods can be used to extract valuable REE and Y (collectively, REY) from industrial waste, with the removal of Ra valorizing the residual gypsum for sale as a commercial product (e.g., in construction, agriculture, or other applicable fields).

Phosphogypsum is the industrial waste product of phosphate fertilizer manufacture that is also a secondary source for REY. Due to the presence of decay products (e.g., radium and lead isotopes) of radioactive elements (e.g., uranium (U) and thorium (Th)), it is sufficiently radioactive (greater than 10 picocuries per gram (pCi/g)) such that commercial uses are limited or prohibited in most countries, including the United States of America, resulting in phosphogypsum being stored in large stacks. An important constraint on processing phosphogypsum for REY extraction is to avoid future stacking of the gypsum due to the presence of radioactivity, particularly from the isotope Ra-226. Thus, removal of radium is an essential goal of any REY extraction process that averts stacking. Embodiments of the subject invention can extract REY from solid phosphogypsum while also removing Ra-226. A key part of the success is the prior characterization of the mineral composition of the trace phases within the gypsum that host REY and Ra.

Targeted leaching of REY and Ra from phosphogypsum is possible when the host phases for these elements are known and distinct from gypsum. Knowledge of the mineral composition and properties of the phosphogypsum can be obtained by electron microscopic characterization, X-ray diffraction, and/or chemical imaging of trace elements in minerals (e.g., by laser ablation time-of-flight inductively coupled plasma mass spectrometry (ICP-MS)) constituting the phosphogypsum. Extraction of REY and Ra can be achieved by treating the phosphogypsum with acidic aqueous media at ambient temperature in a reactor at low L:S ratios (e.g., L:S of no more than 15:1, such as in a range of from 1:1 to 15:1) followed by ion exchange chromatography and/or solvent extraction of relevant anions (particularly fluoride (F)) or cations (particularly strontium (Sr) and barium (Ba)) of the leachate to ensure that the mineral hosts remain undersaturated while the gypsum remains saturated in the solvent. In order to increase the efficiency of the extraction, the phosphogypsum can be ground in a slurry mill to ensure that mineral inclusions are fully accessed by the solvent.

In the related art, acidic leaching of phosphogypsum to attempt to extract REE often includes heating (e.g., up to a temperature of 125° C.). Such leaching does not remove Ra from the phosphogypsum, leaving a radioactive residue in need of continued storage. Also, aqueous leaching of phosphogypsum to dissolve gypsum, followed by REE and Ra extraction, can obtain close to pure gypsum and rare earth fractions, but the cost of water, energy, and/or land to reclaim the gypsum by evaporation is very high compared to the value of the gypsum, rendering this technique not cost-effective in arid (water limitation) or humid (limited evaporation) climates, or in regions where real estate prices are high.

Compared to acidic extraction of REY alone, embodiments of the subject invention enable the selective removal of Ra even though Ra is present in more insoluble minerals than gypsum. The ability to valorize the gypsum residue by removal of Ra effectively reduces the need to stack gypsum, saving costs incurred by the industry on land and engineering controls for the stacks. The rare earth extraction involves zero liquid discharge due to the use of a closed loop. Further, embodiments of the subject invention can include selective extraction at low L:S ratios, which lead to a huge water savings (from a L:S ratio of 500:1 to a L:S ratio of no more than 15:1) that also diminishes the need to subsequently evaporate the water to recover the gypsum. This saves on land for secondary stacks (evaporative surface areas) and/or energy (thermal evaporation), while also valorizing the gypsum such that it can be used as a commercial product.

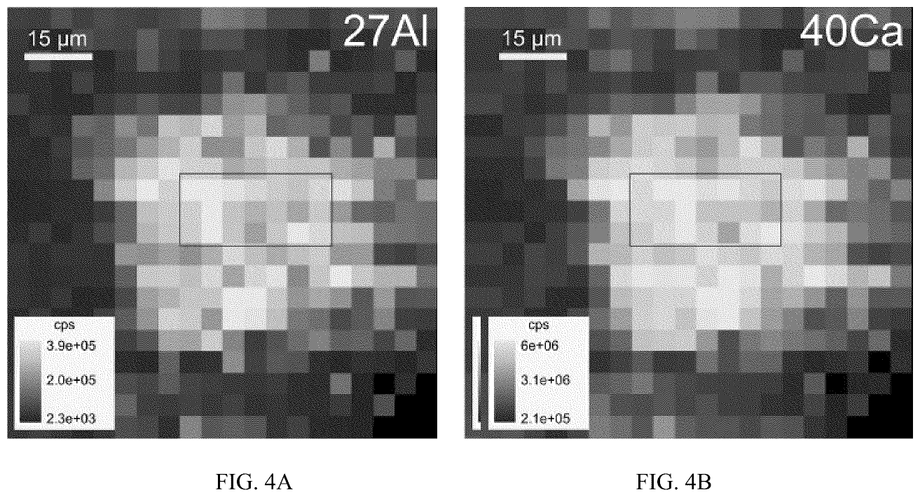

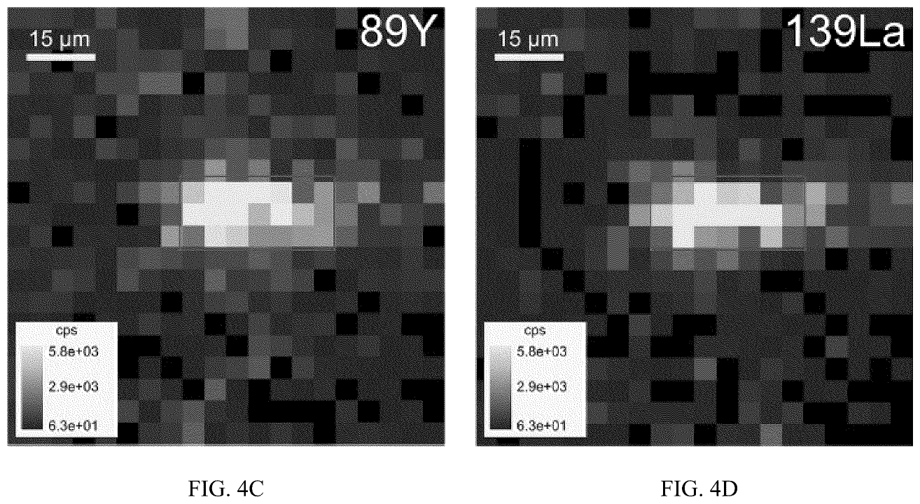

The use of L:S ratios of no more than 15:1 (e.g., in a range of from 1:1 to 15:1 or from about 1:1 to about 15:1) in systems and embodiments of the subject invention overcome the disadvantages of some prior art processes by using a hundred times less water. Important steps include the characterization of the non-gypsum phases in the phosphogypsum using various imaging techniques (e.g., scanning electron microscopy (SEM), chemical mapping of trace REY, Sr, and Ba by laser ablation time-of-flight ICP-MS, in situ imaging of Ra hosts by alpha autoradiography and mineral abundances by X-ray diffraction). In central Florida phosphogypsum, the principal host of REY is chukhrovite (Ca₃Al₃(SO₄)F₁₃·12H₂O), a Ca—Al-fluoride ubiquitously present in phosphogypsum, while the radium is in barite (BaSO₄) or barium-celestite (Sr₁₋ₓBaₓSO₄). The distribution of REY in chukhrovite from central Florida phosphogypsum is shown in FIGS. 4A-4D.

In embodiments, dilute mineral acids (e.g., <2 molar (M), such as less than 1 M) at room temperature (e.g., 25° C. or about 25° C.) can be employed using crushing of phosphogypsum to liberate mineral inclusions for high recoveries of REY at variable L:S ratios (e.g., L:S of no more than 15:1, such as in a range of from 1:1 to 15:1). Systems and methods of embodiments of the subject invention are both more economical than related art methods due to the reduction in volume of leachate (water) that saves both water and energy costs to reclaim gypsum and the lower concentration of acidic media needed for leaching relative to related art methods.

In some embodiments, comminution of the phosphogypsum can be applied to liberate mineral inclusions in order to improve the efficiency of extraction of REY. For example, phosphogypsum can be treated with a dilute acidic medium (e.g., 0.1 N nitric acid) at a L:S ratio of less than 15:1 (e.g., 1:1) at ambient temperature (e.g., 25° C.). The rare earth-bearing liquor can then be physically separated from the leached gypsum residue. In order to determine whether the reaction was completed, and to reduce the phosphate content of the phosphogypsum, an additional leaching step can be applied, which can use another dilute acidic medium (e.g., 2 N nitric acid). This second dilute acidic medium can be stronger than the first dilute acidic medium used to treat the phosphogypsum.

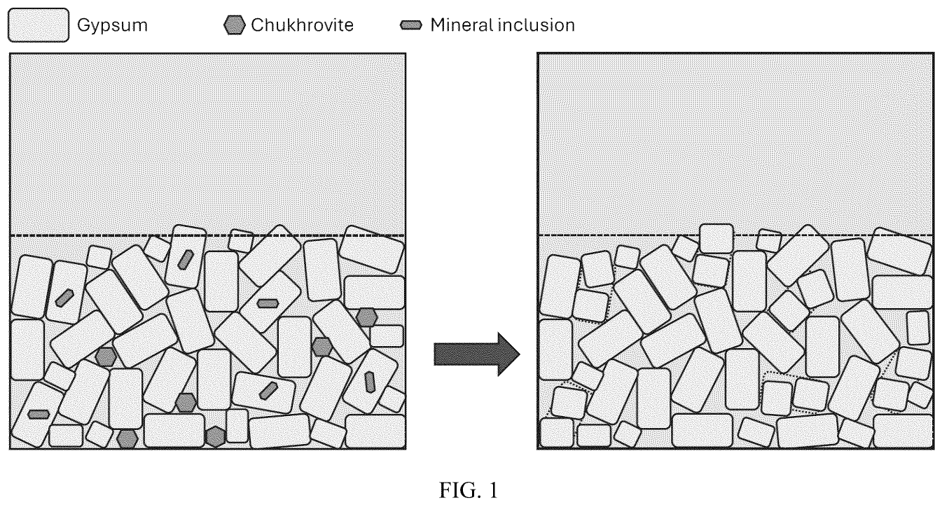

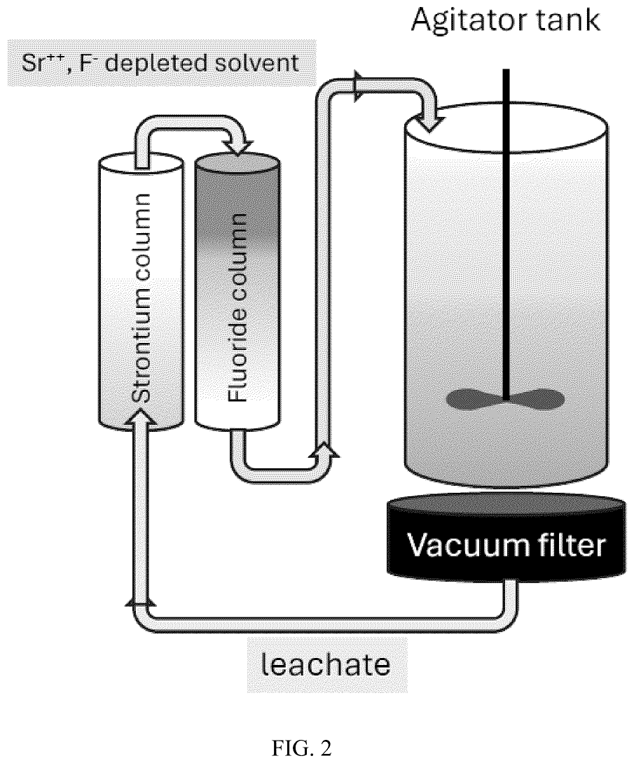

In order to effectively separate REY from phosphogypsum, chukhrovite or other fluorides should be dissolved (see also FIG. 1). Dissolution can occur in, for example, ultrapure water alone but this would require extremely large volumes of water (i.e., L:S ratio of greater than 50,000:1). Instead, in embodiments, at a L:S ratio of no more than 15:1, the gypsum-saturated solution can be recirculated over the phosphogypsum after passing through a fluoride-removal cartridge (see also FIG. 2). This cartridge can be loaded with fine-grained alumina (Al₂O₃) or aluminum hydroxide (Al(OH)₃), resulting in the fixing of insoluble AlF₃, as follows.

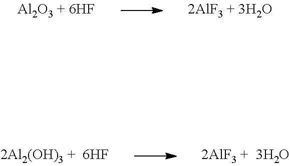

Thus, the solution can act as a transfer agent for fluorine from the phosphogypsum to the alumina-based fluoride trap where it is converted to AlF₃, a product that finds value in the Bayer process, and the defluorinated solvent can be recirculated back to the reaction vessel (e.g., agitator tank as shown in FIG. 2). The REY can form soluble nitrates and can be removed from the residual solid phosphogypsum.

In order to effectively separate Ra-226 from the solid residue, the carrier phase of Ra should be forced to undersaturation in the recirculating solution. A substantial portion of the Ra is in barium-celestite (Sr₁₋ₓBaₓSO₄) that contains a Sr:Ba ratio of about 5:1, where Ra-226 is present in the microcurie range. Because there is a huge excess of available sulfate in gypsum, removal of Sr from the recirculating fluid provides a path to dissolution of the celestite. Referring to FIG. 2, this can be accomplished by placing a Sr-specific resin (e.g., Eichrom Sr-Spec™ resin) column in series with the fluoride removal column. The mass fraction of Sr in the initial solid can be, for example, about 1:1,000, while the resin capacity for Sr is large. The partition coefficient for Sr is nearly three orders of magnitude greater than for calcium (Ca) in the Sr-specific resin (e.g., Sr-Spec™), so that at the Ca-nitrate molarity in the solution (e.g., about 0.05 M) the matrix-loading on the resin does not reduce the partitioning of Sr (see also; Horowitz et al., A novel strontium-selective extraction chromatographic resin, Solvent Extraction and Ion Exchange 10, 29, 1992, eichrom.com/wp-content/uploads/2018/02/HP292-Sr-in-Mixed-Samples.pdf; which is hereby incorporated by reference herein in its entirety). The resin capacity is about 8 milligrams (mg) of Sr per milliliter (mL) of resin requires a minimum of 1 mL of resin per 10 grams (g) of phosphogypsum. The resin can be recharged by elution of the column-bound Sr with a dilute acidic medium (e.g., nitric acid) or deionized water, and then reused (e.g., up to a thousand times). Thus, the consumption of resin can be about 1 mL per 10 kilograms (kg) of phosphogypsum.

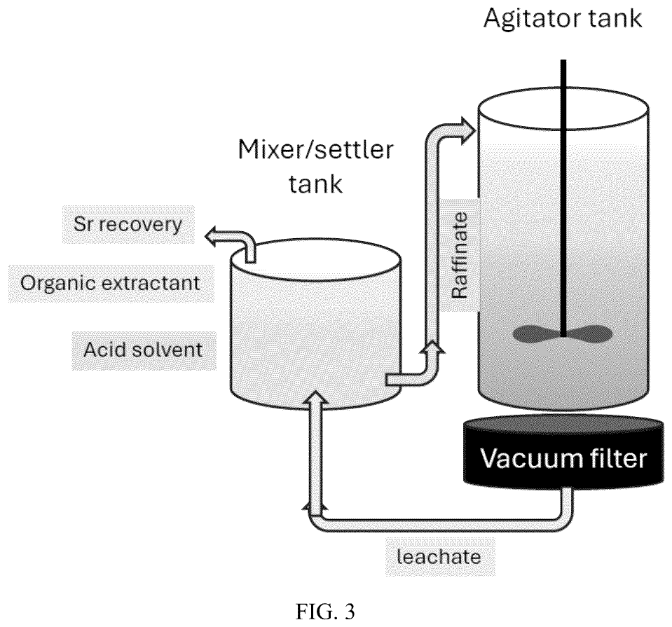

In some embodiments, solvent extraction employing the same crown ether (e.g., 4,4′(5′)-bis(t-butylcyclohexano)-18-crown-6) can be employed to remove Sr from the recirculating gypsum solution in place of an Sr-specific resin by replacing the ion exchange column with a mixer-settler tank, as shown in FIG. 3. The raffinate (Sr-depleted solution) can be recirculated back to the agitator tank to dissolve more Sr. For large-scale applications, solvent extraction for Sr removal would be more effective than the use of a stationary phase resin.

The remaining residue after these steps holds most of the gypsum and sand, containing some REY bound in sand grains (e.g., zircon) that cannot be profitably accessed by current rare earth extraction technologies. The extracted acidic media (gypsum solution) can then be neutralized, and the REY can be precipitated (e.g., using existing technologies) to yield a bulk rare earth carbonate and/or rare earth oxalate.

Embodiments of the subject invention use lower volumes of solvent (dilute acid) at ambient temperatures to liberate REY, thereby requiring less acid and no thermal energy for dissolution, while also including fracturing of the gypsum compared with related art processes for attempting to extract REY from phosphogypsum. This represents a savings of a hundred-fold or more in water use over processes that remove the gypsum selectively and saves the need to evaporate the water to recover gypsum. In addition, Ra reduction can be accomplished without the need to dissolve the bulk of the gypsum, valorizing the gypsum and reducing or eliminating the need for stacking the gypsum. This is an advantage over related art methods for REY extraction. Further, the targeted dissolution of the identified carriers enables more efficient recovery of REY than by related art methods. The efficiency, energy requirements, and acid disposal needs make systems and methods of embodiments of the subject invention more cost-effective and safer than related art processes. Embodiments solve an outstanding issue that. without Ra removal, no method is competitive in the U.S. market.

There are nearly two billion tons of phosphogypsum stacked globally with more than a billion tons stacked in Florida. Valorization of the gypsum would add considerable gypsum inventory to the global market. The U.S. mines about 15 million tons of natural gypsum per year and imports another 5 million tons per year for a total of about 20 million tons per year, principally for use in construction as wallboard, cement, and plaster, in agriculture as a soil amendment for sulfur in wheat, corn, cotton, and other major crops, and in food and other applications. In comparison, the U.S. fertilizer industry produces approximately 20 million tons of phosphogypsum per year that requires stacking due to the presence of natural radioactive contaminants in the phosphorite ore, principally Ra-226. Reduction of radioactivity in this product to acceptable levels, as with embodiments of the subject invention, can enable replacing both mine production and imports of natural gypsum with this industrial byproduct.

The Florida phosphogypsum contains nearly half a million tons of REY, which is equivalent to a half-century supply at the current rate of U.S. REY consumption. The extracted REY would form the input for a domestic rare earth separation supply chain, yielding materials from which permanent magnets (Nd—Fe—B, Sm—Co) are developed for use in electric vehicle (EV) traction motors, wind turbine generators, and other applications, including in military applications, particularly the F-35 fighter program. REY are used in the production of high-temperature superconductors (yttrium-barium copper oxide (YBCO) and rare earth-barium copper oxide (REBCO)). Tapes of YBCO and REBCO are the basis of high temperature superconductor magnets employed in the nuclear fusion energy industry and in Magnetic Resonance Imaging (MRI) instruments. The REY derived from phosphogypsum are rich in terbium, dysprosium, and yttrium, in contrast to the most abundant rare earth ores associated with hard-rock deposits (bastnösite, REE-carbonate; loparite, a REY-bearing perovskite, CaTiO₃) that lack commercially extractable quantities of such heavy rare earths. While supplies of Nd may be derived from either type of ore, there is a dearth of ores that can supply the heavy rare earths (Tb, Dy) needed to provide resistance to demagnetization at operating temperatures of permanent magnets. Likewise, bastnösite ores do not yield significant quantities of yttrium for manufacture of YBCO tape, while phosphorite ores and their phosphogypsum waste would be important sources of yttrium. In addition, extracted Ra-226 from phosphogypsum could be a raw material for radiopharmaceuticals because neutron irradiation of Ra-226 yields medical isotopes for targeted alpha radiotherapy, including Ra-223 and Ac-225.

When ranges are used herein, combinations and subcombinations of ranges (e.g., any subrange within the disclosed range) and specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein (including those in the “References” section, if present) are incorporated by reference in their entirety, including all figures and tables, to the extent they are not inconsistent with the explicit teachings of this specification.

### REFERENCES

U.S. Patent Application Publication No. U.S. 2012/0114538 (Abramov et al.).
Gypsum Association (2024) Gypsum and the Economy (gypsum.org/gypsum-and-the-economy/); Other Uses of Gypsum (gypsum.org/other-uses-of-gypsum/); accessed Aug. 14, 2024.
Horowitz E. P., Chiarizia R and Dietz M. L. (1992) A novel strontium-selective extraction chromatographic resin. Solvent Extraction and Ion Exchange 10, 29 pp. eichrom.com/wp-content/uploads/2018/02/HP292-Sr-in-Mixed-Samples.pdf.
Russian Patent RU2487834C1, Kolyasnikov S. V., Borisov M. M., Kirillov E. V. and Rybina M. L. (2013) Extraction Method of Rare-Earth Metals from Phosphogypsum., 20 Jul. 2013. patents.google.com/patent/RU2487834Cl/en?oq=RU2487834C1.
Li S., Malik M. and Azimi G. (2022) Extraction of rare earth elements from phosphogypsum using mineral acids: process development and mechanistic investigation. Industrial and Engineering Chemistry Research 61, 102-114, doi.org/10.1021/acs.iecr.1c03576.
Liang H., Zhang P., Jin Z. and DePaoli D. (2017) Rare earths recovery and gypsum upgrade from Florida phosphogypsum. Minerals & Metallurgical Processing 34, 201-206, doi.org/10.19150/mmp.7860.
Poty S., Francesconi L. C., McDevitt M. R., Morris M. J. and Lewis J. S. (2018) a-emitters for radiotherapy: From basic radiochemistry to clinical studies-Part 1. Journal of Nuclear Medicine 59, 878-884, doi.org/10.2967/jnumed.116.186338.
Russian patent RU2509726C2, Rychkov V. N., Kirillov E. V., Smirnov, A. L., Jazev V. A. and Ivanko V. A. (2014) Method of Extracting Rare-Earth Elements from Phosphogypsum. 20 Mar. 2014. patents.google.com/patent/RU2509726C2/en?oq=RU2509726C2.
Xie G., Guan Q., Zhou F., Yu W., Yin Z., Tang H., Zhang Z. and Chi R. (2023) A critical review of the enhanced recovery of rare earth elements from phosphogypsum. Molecules 28, 20 pp., doi.org/10.3390/molecules28176284.

What is claimed is:

1. A method for extraction of rare earth elements (REE), yttrium (Y), and/or radium (Ra) from phosphogypsum, the method comprising:
i) treating the phosphogypsum with an acidic aqueous medium in a reactor at a liquid:solid (L:S) ratio of no more than 15:1 to give a first solution comprising dissolved gypsum and to leave behind a gypsum residue;
ii) performing a chemical extraction step on the first solution to remove at least one anion and/or at least one cation and give a second solution comprising dissolved gypsum, the second solution being undersaturated in the at least one anion and/or the at least one cation compared to the first solution;
iii) treating the gypsum residue with the second solution to extract more of the at least one anion and/or at least one cation from the gypsum residue;
iv) performing the chemical extraction step on the second solution after step iii) to remove the at least one anion and/or the at least one cation, the second solution after this chemical extraction being undersaturated in the at least one anion and/or the at least one cation compared to the second solution before this chemical extraction step;
v) repeating steps iii) and iv) a plurality of times to give a final gypsum residue and a third solution comprising REE, Y, and/or Ra; and
vi) precipitating REE and/or Y from the third solution,
wherein the chemical extraction step comprises at least one of ion exchange chromatography and solvent extraction.

2. The method according to claim 1, wherein the L:S ratio is in a range of from 1:1 to 15:1.

3. The method according to claim 1, wherein step i), step ii), step iii), step iv), and step v) are performed at ambient temperature.

4. The method according to claim 1, wherein step vi) comprises first neutralizing the third solution.

5. The method according to claim 1, wherein a concentration of Ra in the final residual gypsum is at least 90% less than that of the phosphogypsum.

6. The method according to claim 1, wherein final residual gypsum has a radium activity of 10 picocuries per gram (pCi/g) or less.

7. The method according to claim 1, further comprising:
either before step i) or concurrent with step i), grinding the phosphogypsum,
wherein the grinding of the phosphogypsum is performed in a slurry mill before step i).

8. The method according to claim 1, wherein the acidic aqueous medium has a concentration of acid in a range of from 0.01 molar (M) to 2 M.

9. The method according to claim 1, wherein the acidic aqueous medium comprises at least one mineral acid.

10. The method according to claim 1, wherein the at least one anion comprises fluorine, and
wherein the at least one cation comprises at least one of strontium and barium.

11. The method according to claim 1, wherein step ii) comprises passing the first solution through at least one of: a fluoride-removal stage configured to remove fluorine from the first solution; and a strontium-removal stage configured to remove strontium from the first solution, and
wherein step ii) comprises, after passing the first solution through the fluoride-removal stage and/or the strontium-removal stage, recirculating the second solution back to the reactor.

12. The method according to claim 11, wherein the fluoride-removal stage comprises a fluoride-removal cartridge comprising at least one of alumina (Al₂O₃) and aluminum hydroxide (Al(OH)₃), and
wherein the strontium-removal stage comprises at least one of: a strontium-specific resin column; and solvent extraction using a Sr-specific crown ether.

13. The method according to claim 12, wherein the Sr-specific crown ether is 4,4′(5′)-bis(t-butylcyclohexano)-18-crown-6.

14. The method according to claim 1, wherein step iv) comprises passing the second solution through at least one of: a fluoride-removal stage configured to remove fluorine from the second solution; and a strontium-removal stage configured to remove strontium from the second solution, and
wherein step iv) comprises, after passing the second solution through the fluoride-removal stage and/or the strontium-removal stage, recirculating the second solution back to the reactor.

15. The method according to claim 14, wherein the fluoride-removal stage comprises a fluoride-removal cartridge comprising at least one of alumina (Al₂O₃) and aluminum hydroxide (Al(OH)₃), and
wherein the strontium-removal stage comprises at least one of: a strontium-specific resin column; and solvent extraction using a Sr-specific crown ether.

16. The method according to claim 15, wherein the Sr-specific crown ether is 4,4′(5′)-bis(t-butylcyclohexano)-18-crown-6.

17. The method according to claim 1, wherein step v) comprises repeating steps iii) and iv) at least three times before step vi) is performed.

18. The method according to claim 1, wherein step ii) comprises using an extraction means to extract the first solution from the reactor,
wherein step iv) comprises using the extraction means to extract the second solution from the reactor, and
wherein the extraction means comprises at least one of a vacuum filter and a centrifuge.

19. The method according to claim 1, wherein a ratio of the mass of the REE obtained in step vi) to the mass of the REE present in the phosphogypsum is at least 80%,
wherein a ratio of the mass of the Y obtained in step vi) to the mass of the Y present in the phosphogypsum is at least 80%, and
wherein a ratio of the mass of gypsum in the final gypsum residue to the mass of gypsum in the phosphogypsum is at least 95%.

20. The method according to claim 1, wherein step vi) comprises precipitating REE and Y (collectively, REY) as REY-carbonate, REY-oxalate, and/or REY-hydroxide.
